(19) United States
(12) Patent Application Publication
(10) Pub. No.: US 2004/0121654 A1
(43) Pub. Date: Jun. 24, 2004

(54) Battery connector

(76) Inventors: Lei Chao, Shanghai City (CN); Chao-Yun Sun, Shanghai City (CN)

Correspondence Address: MOLEX INCORPORATED, 2222 WELLINGTON COURT, LISLE, IL, 60532, US

(21) Appl. No.: 10/655,720

(22) Filed: Sep. 5, 2003

(30) Foreign Application Priority Data
Sep. 5, 2002 (TW) 91213997

(51) Int. Cl. H01R 24/00

(52) U.S. Cl. 439/660

(57) ABSTRACT

A battery connector includes an insulating housing and a plurality of electrical terminals. The insulating housing has a bottom wall, a front wall, a rear wall a plurality of vertical walls arranged alternatively on the bottom wall, and a plurality of terminal receiving slots relatively formed between each of pairs the vertical walls. The electrical terminals are respectively received in the terminal receiving slots, and the electrical terminals each has a body, a conducting portion, a resilient arm, and a contacting portion. The conducting portion extends from a first side of the body, the resilient arm extends upwardly from a second side of the body, and the contacting portion connects one end of the resilient arm, which has another end connects to the body. The electrical terminals respectively orients in the terminal receiving slots, the conducting portion exposes below and extends outwardly from the bottom wall thereof, and the contacting portion including a contact point that is located outwardly from the front wall in a direction away from the rear wall.

### FIELD OF THE INVENTION

The present invention relates to a battery connector. More particularly, the present invention relates to a battery connector the can receive a battery from either a vertical direction or a horizontal direction.

### DESCRIPTION OF THE RELATED ART

In normal electronic devices, such as a cell phone, usually uses a battery connector to provide an electrical connection between one of the electronic devices and a battery.

Referring to the FIG. 1, FIG. 2 and FIG. 3, T.W. Patent Application No 91200828, which is filed on Jan. 28, 2002, discloses a vertical battery connector including an insulating housing 1, and a plurality of electrical terminals 2, wherein the insulating housing 1 is a vertical housing and includes a bottom wall 11, a front wall 12, and a plurality of vertical walls 13 extending a face of the bottom wall 11 upwardly and parallel arranged in an alternative way. Pairs of the vertical walls 13, which is one and another adjacent to the one, together sandwiches a plurality of spaces therebetween, the spaces are respectively defines a plurality of the receiving slots 14, The front wall 12 has an opening 121 relative and communicating to each of the receiving slots 14, for penetrating the receiving slots 14 from a front to a rear thereof. The receiving slots 14 each has two facing walls 141, 142, which is respectively formed on two of the vertical walls 13 sandwiching the receiving slots 14. The two facing walls 141, 142 respectively outwardly extends two blocks 144 adjacent to a bottom face 143 and spaced from the bottom face 143 of the insulating housing 1, and the two blocks 144 opposite to and not contact each other, wherein the two blocks 144 and the bottom face 143 together define a clamping slot 145.

Besides, the bottom wall 11 of the insulating housing 1 downwardly extends a plurality of partitions 111, which each is integrally made in one piece and with respect to each of the vertical walls 13, for making a plurality of limiting slots 112 formed between one of the partitions 111 and another adjacent to the one. Two outermost of the vertical walls 13 respectively exposes outwardly two clamping blocks 131 for correctly orienting to a casing of an electronic device while the battery connector assembly therein.

The electrical terminals 2 are respectively with respect to and received to a plurality of receiving slots 14. Each of the electrical terminals 2 is a vertical terminal, and has a body 21, a conductive portion 22, a resilient arm 23, and a contacting portion 24. The body 21 is a rectangular sheet laterally arranged, and has a first side 211 and a second side 212 opposing to the first side 211. The conducting portion 22 extends tilting downwardly first and upwardly later towards the second side 212 and is in a hook shape, the conducting portion 22 has a first portion 221 tilted downwardly and a second portion 222 tilted upwardly and integrally extending from the first portion 221, and the first portion 221 meets the second portion 222 and has a point to press a joint of a printed circuit board 3.

The second side 212 of the body 21 extends upwardly an accurate resilient arm 23 integrally made in one piece, and the resilient arm 23, which has one end connecting the second side 212, has another end integrally connecting the contacting portion 24 in a V shape laterally disposed. The contacting portion 24 has an opening facing the first side 211 of the body 21, and the contacting portion 24 has a first arm 241 and a second arm 242. Wherein the first arm 241 extends outwardly from one end of the resilient arm 23, which has another end connecting the second side 212, and integrally made in one piece. The first arm 241 is bent to be a V shape and has an end extending upwardly integrally as being the second arm 242, and the second arm has a free end to be a clamping portion 25.

As in assembly, the body 21 of each of the electrical terminals 2 is arranged into the insulating housing 1 from a rear thereof and respectively with respect to the receiving slots 14, the electrical terminals 2 locates in the clamping slots 145 and move forwardly gradually to retain against a top edge 122 of the front wall 12 and the assembly process is therefore accomplished. After assembly, the body 21 of each of the electrical terminals 2 is clamped by the two blocks 144 of the clamping slots 145, and a latching member (not shown) disposed on the body 21 clamps a wall of each of the clamping slots 145, thus the body 21 could orient in each of the clamping slots 145 for firmly fixing the electrical terminals 2 into the corresponding receiving slots 14. The conducting portion 22 is exposing below and out of the bottom wall 11 of the insulating housing 1, and the conducting portion 22 could electrically connects the printed circuit board 3 after the battery connector assembled in the electronic device. Furthermore, the conducting portion 22 locates in each of the limiting slots 112, and is limited right and left movements by the partitions 111 for further efficiently prevent the imperfect contact to the printed circuit board 3 from the shifting of the conducting portion 22.

The contacting portion 24 of each of the electrical terminals 2 extends to retain against the front wall 12 of the insulating housing 1 from each of the receiving slots 14. A battery 4 aligns with the electrical terminals 2 from a front of the battery connector while the battery connector electrically connects to the battery 4, and the battery 4 moves backwardly until corresponding terminals disposed thereof respectively retains against the contacting portions 24 therefore driving the resilient arm 23 turns from a front to a rear of the receiving slots 24. The resilient arm 23 forces the contacting portion 24 forward to tightly contact the corresponding terminals by a restoring elastic resistance thereof and thus the battery connector electrically connects the battery 4.

However, the battery connector is designed for connecting the battery 4 in a front forward direction to the electrical terminals 2 (as indicated by an arrow A). Referring to the FIG. 3, if the battery 4 connects to the electrical terminals 2 in a top-to-bottom direction as indicated by an arrow B, the battery connector could not be firmly connecting the battery 4 and the electrical terminals 2 could be easily deformed and damaged, while the contacting portion 24 moves and shifts downwardly.

Therefore, the battery connector mentioned above has obvious shortages while the battery 4 assembled in a top-to-bottom way, and could be improved.

### SUMMARY OF THE INVENTION

A primary object of the present is to provide a battery connector firmly connecting a battery and a electrical terminals could not be deformed and damaged because of a contacting portion moves and shifts downwardly, while the battery connects in a top-to-bottom direction to the contacting portion of the battery connector.

Another object of the present invention is to provide a battery connector that is capable of receiving a battery from either a vertical or a horizontal direction.

A battery connector according to the present invention includes an insulating housing and a plurality of electrical terminals. The insulating housing has a bottom wall, a front wall, a rear wall, a plurality of vertical walls extending upwardly from the bottom wall, and a plurality of terminal receiving slots formed between each pair of vertical walls. The electrical terminals are respectively received in the terminal receiving slots, and the electrical terminals each has a body, a conducting portion, a resilient arm, and a contacting portion. The conducting portion extends from a first side of the body, the resilient arm extends upwardly from a second side of the body, and the contacting portion connects one end of the resilient arm, which has another end connects to the body. The electrical terminals respectively orients in the terminal receiving slots, the conducting portion exposes below and extends outwardly from the bottom wall thereof, and the contacting portion, which includes a contact point, extends outwardly from the front wall in a direction away from the rear wall.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a prior art battery connector;

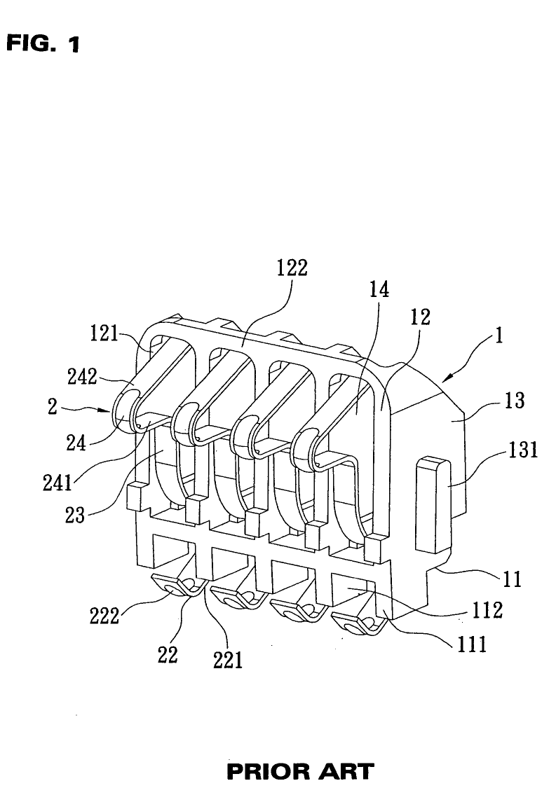

FIG. 2 is a perspective view with another angle of the prior art battery connector;

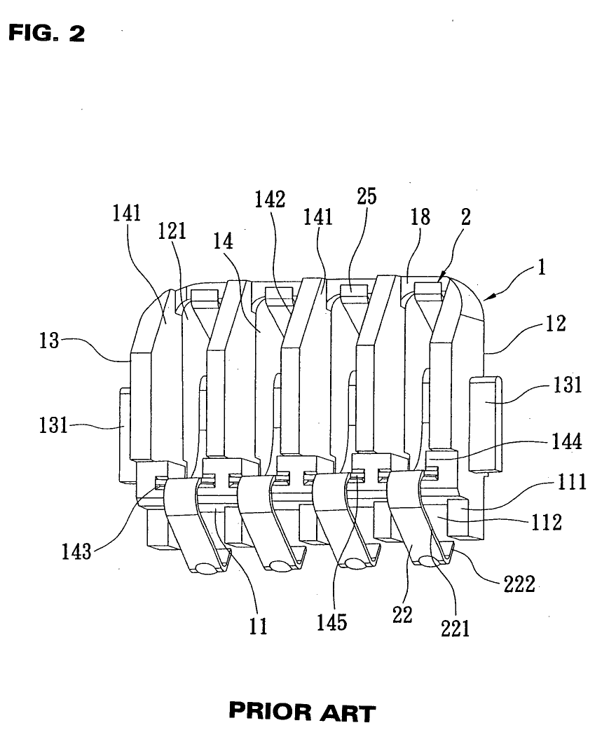

FIG. 3 is a profile according to the prior art battery connector connecting a PCB;

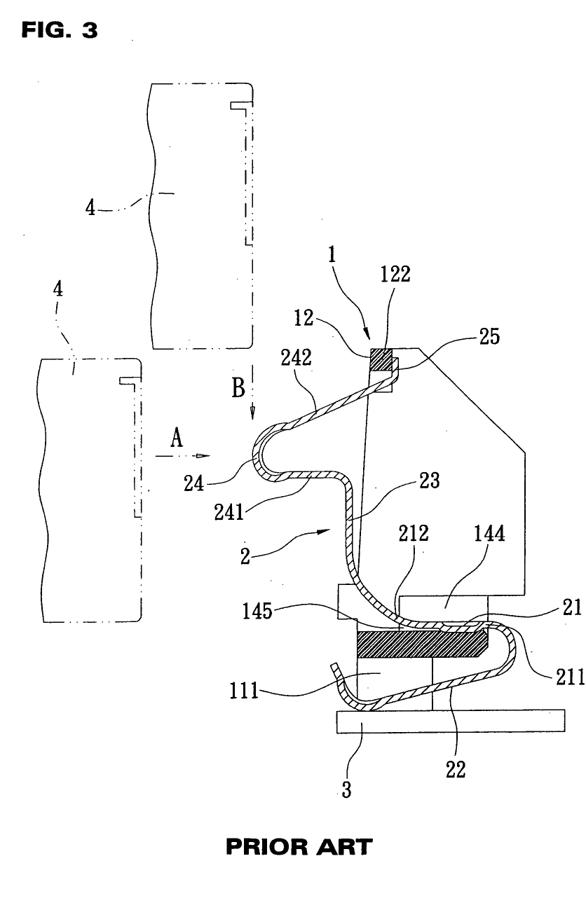

FIG. 4 is a perspective view of the present invention battery connector;

FIG. 5 is a perspective view with another angle of the present invention battery connector;

FIG. 6 is a perspective view of an insulating housing;

FIG. 7 is a perspective view of with another angle of the insulating housing.

FIG. 8 is a perspective view of an electrical terminal;

FIG. 9 is a perspective view with another angle of the electrical terminal; and

FIG. 10 is a profile according to the present invention battery connector connecting a PCB.

### DETAILED DESCRIPTION OF THE DISCLOSED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

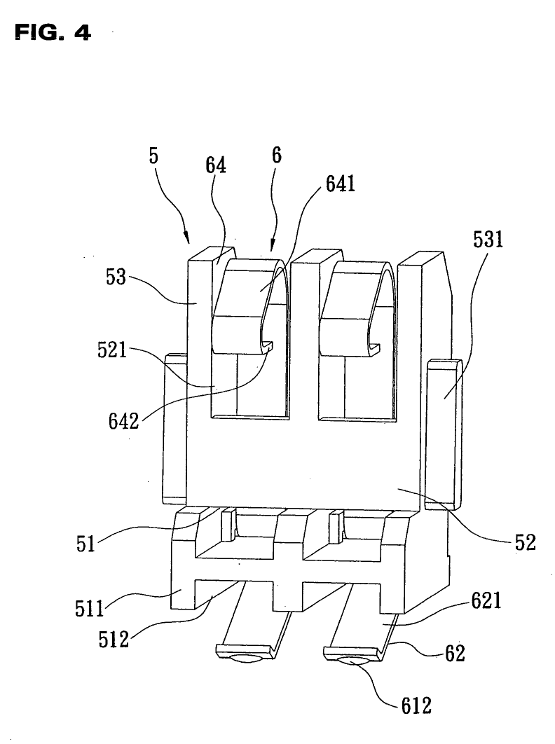

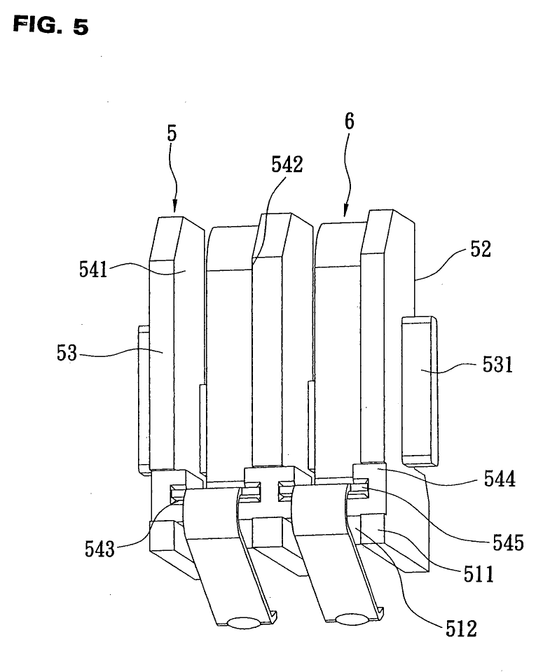

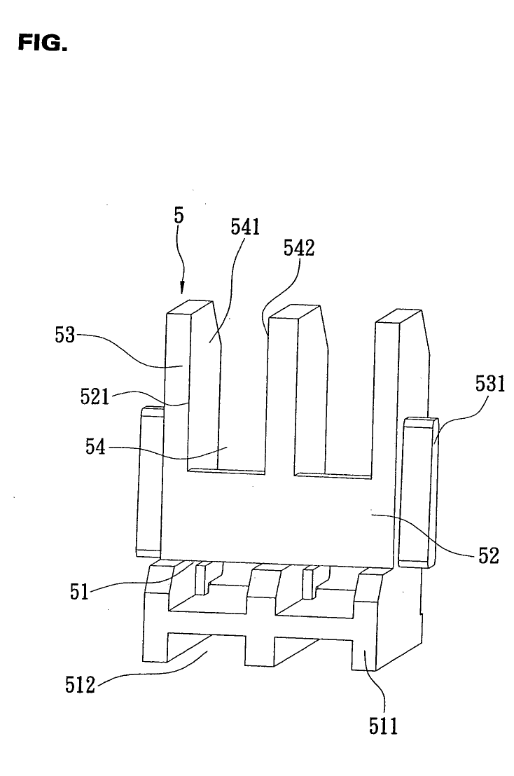

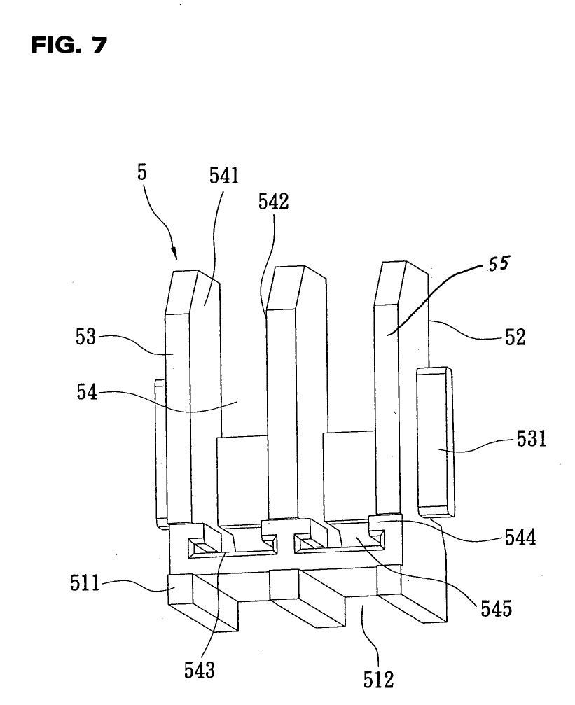

Referring to the FIG. 4 and FIG. 5, the present invention provides a battery connector assembling to a printed circuit board of a cell phone for electrically mating to a corresponding joint, electrically connecting to a battery in the cell phone. The battery connector includes an insulating housing 5 and a plurality of electrical terminals 6, wherein the insulating housing 5 is a vertical housing and has a bottom wall 51, a front wall 52, a rear wall 55, a plurality of vertical walls 53 (please referring to the FIG. 6 and the FIG. 7 at the same time) arranged alternatively on the bottom wall 51, and a plurality of terminal receiving slots 54 relatively formed between each of pairs the vertical walls 53, the front wall 52 has a plurality of openings 521 respectively communicating with the terminal receiving slots 54 for penetrating through the terminal receiving slots 54. Each pair of the vertical walls 53 sandwiching one of the terminal receiving slots 54, has two opposing walls 541, 542 facing each other and being adjacent to the bottom wall 543, the two opposing walls 541, 542 space a predetermined distance to the bottom wall 543 and further respectively expose inwardly two blocks 544 which keeps no contact with each other and form a clamping slot 545 with the bottom wall 543.

Besides, the bottom wall 51 of the insulating housing 5 has a plurality of partitions 511 integrally downwardly extending thereof and respectively corresponding to the vertical walls 53, and a limiting slot 512 therefore formed between two of the partitions 511, which are adjacent to each other. The two outermost vertical walls 53 thereof respectively expose outwardly a clamping block 531 for orienting with a housing of the electronic device while the battery connector assembly to the electronic device.

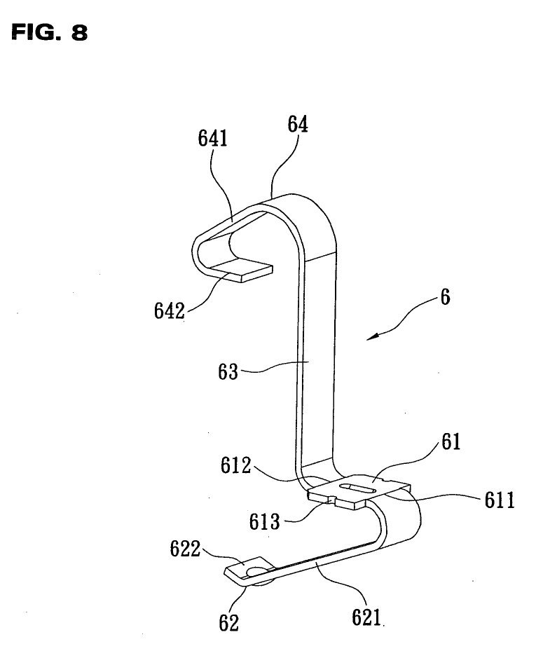

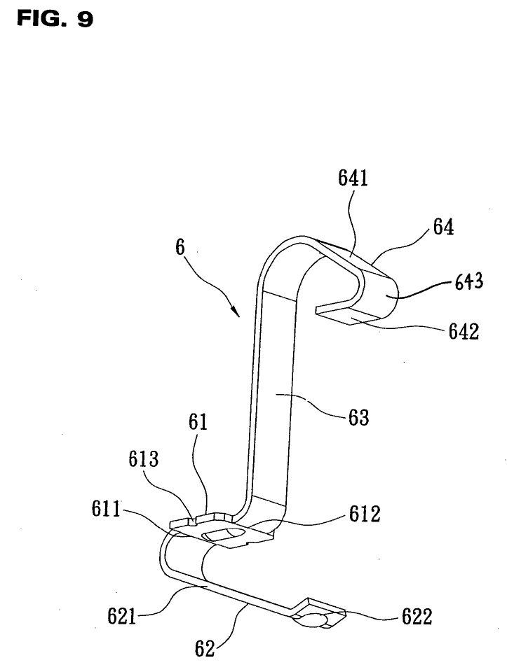

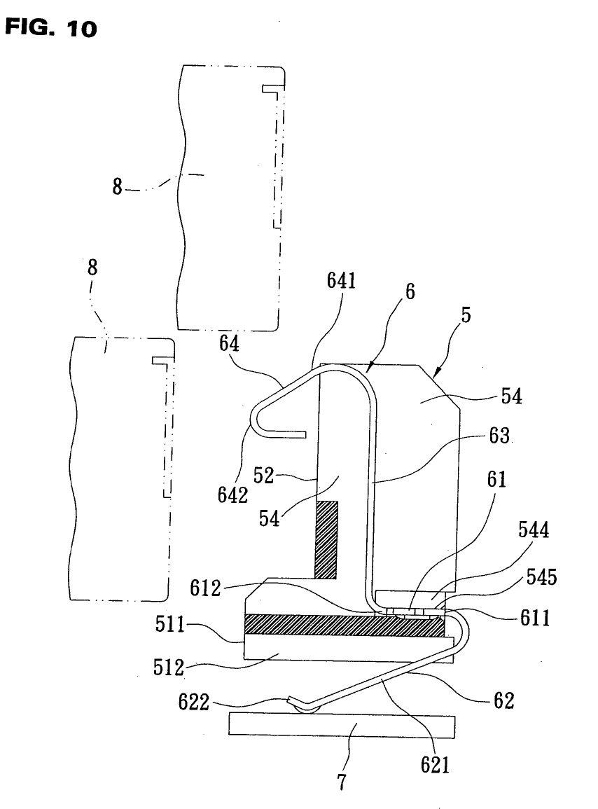

Each of the electrical terminals 6 is respectively received in the corresponding terminal receiving slots 54. Each of the electrical terminals 6 is a vertical terminal and has a body 61, a conducting portion 62, a resilient portion 63, and a contacting portion 64 (please referring to the FIG. 8 and FIG. 9 at the same time), wherein the body 61 is a rectangular sheet disposed transversely and has a first side 611 and a second side 612 opposing to the first side 611. The conducting portion 62 is formed by an extension first downwardly tilting and second upwardly tilting extending from the first side 611 and in a hook shape. The conducting portion 62 has a first portion 621 tilting downwardly and a second portion 622 integrally extending from the first portion 621 and tilting upwardly, the first portion 621 and the second portion 622 cross to press a joint on a printed circuit board 7 (referring to the FIG. 10).

The resilient arm 63 extends from the second side 612 of the body 61 integrally and extends vertically upwardly, the resilient arm 63 has a V-shaped contacting portion 64 integrally connecting to an end of the second side 612, the contacting portion 64 has a first arm 641 and a second arm 642, the first arm 641 integrally downwardly extends from an end of the resilient arm 63 first and then bent a sharp with a generally “V” shape extends laterally integrally to form the second arm 642. A contact point 643 is located between the first arm 641 and the second arm 642, preferably at the point of the generally “V” shape.

In assembly, the electrical terminals 6 respectively insert into corresponding terminal receiving slots 54. The terminal body 61 is located in the clamping slots 545. After assembly, the body 61 of each of electrical terminals 6 is oriented in each of the clamping slots 545 by suppressions with the two clamping blocks 544 and interferences with two interfering members 613 formed of the body 61. The conducting portion 62 is locates under the bottom wall 51 of the insulating housing 5 and exposing out of the bottom wall 51. After assembling to the electronic device, the conducting portion 62 electrically connecting to the PCB 7 and further the conducting portion 62 locates in the limiting slot 512, which has the partitions 511, to limit a displacement of the conducting portion 62 and avoid the imperfect contact between the conducting portion 62 and the PCB 7.

The contacting portion 64 exposes out of the front wall 52 from the terminal receiving slot 54, a battery 8 aligns locations of the electrical terminals 6 from a front of the battery connector and moves to a rear thereof to suppress a corresponding terminals on the contacting portion 64 while the battery connector electrical connects the battery 8. Because of the corresponding terminals retains the contacting portion 64 to the rear thereof to drive the resilient arm 63 deflecting from a front to a rear in the terminal receiving slot 54, and the resilient arm 63 has a contacting resistance generating by the elastic recovery to drive the contacting portion 64 moving forwards to tightly the corresponding terminals to electrically connects the battery connector to the battery 8.

The embodiment of the present invention mentioned above shows the conducting portion 62 and a resilient arm 63 extending from the first side 611 and the second side 612 respectively to make that the conducting portion 62 locates under the body 61 and the contacting portion 64 locates above the body 61, the electrical terminals 6 has a reduced width because of the overlapping and the volume of the present invention therefore is reduced.

Besides, the battery 8 electrically contacts contacting portions 64 of the electrical terminals 6 from up to down, the contacting portion 64 stands with no displacements because of its vertical shape, and the battery 8 retains the contacting portion 64 to move backwards, the goals of firmly connection between the battery connector and the battery 8 without any plastic deformation and damage to the electrical terminals. Likewise, the battery 8 can electrically contact the contacting portions 64 of the terminals by being moved in a front to rear direction relative to the connector while at the same time not causing any plastic deformation or damage to the electrical terminals.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A battery connector comprising:
an insulating housing has a bottom wall, a front wall, a rear wall and a plurality of vertical walls extend upward from the bottom wall, wherein a plurality of terminal receiving slots are formed between each pair of the vertical walls; and
a plurality of electrical terminals respectively received in the terminal receiving slots, the electrical terminals each having a body, a conducting portion, a resilient arm, and contacting portion, wherein the body has a first side and a second side opposing to the first side, the conducting portion extends from the first side, the resilient arm has an end connecting the second side upwards straightly, the contacting portion connects an other end of the resilient arm, the electrical terminals orients in the corresponding terminal receiving slots, the conducting portion locates under and exposes out of the bottom wall, and the contacting portion includes a contact point that is located outwardly from the front wall in a direction away from the rear wall.

2. The battery connector of claim 1, wherein the insulating housing is a vertical housing, the electrical terminals are vertical terminals.

3. The battery connector of claim 1, wherein the insulating housing has two outermost vertical walls respectively two clamping blocks exposing outwardly thereof.

4. The battery connector of claim 1, wherein each of the terminal receiving slots has a right and a left vertical wall facing to each other and being adjacent to the bottom wall, and two clamping blocks spacing a predetermined distance from the bottom wall, wherein the clamping blocks and the bottom wall define a clamping slot, the body of each of the electrical terminals locates in the clamping slots, and the body of each of the electrical terminals orients in the each of the terminal receiving slot by suppressions with the clamping blocks and the interferences of the clamping slots.

5. The battery connector of claim 1, wherein the bottom wall has a plurality of partitions extending downwardly integrally under thereof and respectively corresponding to the vertical walls, which are adjacent to each other, and a limiting slot formed between two of the partitions, the conducting portion locates in the limiting slot and is right and left displacement limited by the partitions.

6. The battery connector of claim 1, wherein the body of each of the electrical terminals is a rectangular sheet transversely disposed.

7. The battery connector of claim 1, wherein the conducting portion has a first portion tilting downwardly and a second portion integrally extending from the first portion and tilting upwardly.

8. The battery connector of claim 1, wherein the contacting portion has a first arm and a second arm, the first arm integrally downwardly extends from an end of the resilient arm first and then extends laterally integrally to form the second arm.
